(19) United States
(12) Patent Application Publication
(10) Pub. No.: US 2011/0161923 A1
(43) Pub. Date: Jun. 30, 2011

(54) PREPARING NAVIGATION STRUCTURE FOR AN AUDIOVISUAL PRODUCT

(75) Inventor: Stuart Green, Sheffield (GB)

(73) Assignee: ZOOtech Limited, Sheffield (GB)

(21) Appl. No.: 11/568,068

(22) PCT Filed: Apr. 19, 2005
(86) PCT No.: PCT/GB2005/001495

§ 371 Date: Oct. 18, 2006

Related U.S. Application Data
(60) Provisional application No. 60/616,270, filed on Oct. 6, 2004.

(30) Foreign Application Priority Data
Apr. 19, 2004 (GB) 0408599.9

(51) Int. Cl. G06F 9/44; G06F 17/30

(52) U.S. Cl. 717/109; 707/E17.044; 717/139; 717/160; 717/106

(57) ABSTRACT

The system includes a command set defining a plurality of navigation commands for an audiovisual reproduction apparatus and a human-oriented scripting program for automatically authoring a navigation structure for use in a stand alone audiovisual product playable in the audiovisual reproduction apparatus. The scripting program includes an iterative loop with a variable adjusted according to the iterations of the loop. The scripting program is operable to automatically, for each iteration of the loop; select from the plurality of navigation commands a navigation command defined according to the variable as adjusted for each iteration of the loop; and add the navigation command to an intermediate representation of the navigation structure. An associated method is also provided.

The present invention relates in general to a method and apparatus for preparing a navigation structure for an audiovisual product, and in particular for an audiovisual product playable according to an optical disc format specification.

In general terms, an audiovisual product such as a movie or other presentation is formed by gathering together many small sections or clips of raw audio and visual content. This is usually termed an “authoring” process wherein the raw sound clips, still images and video clips are progressively assembled and edited together to form the finished audiovisual product. The audiovisual product is then recorded on some form of recording media. Traditionally, this would be an analogue medium such as celluloid film or analogue video tape (e.g. VHS format video tape). More recently, it has become possible to record audiovisual content onto random access media including in particular optical disc media, or other forms of random storage such as magnetic hard drives. These random access media have many advantages in terms of size, data capacity, playback speed, image quality and so on.

An optical disc is a convenient storage medium for many different purposes. A digital versatile disc (DVD) has been developed with a capacity of up to 4.7 Gb on a single-sided single-layer disc, and up to 17 Gb on a double-sided double-layer disc. There are presently several different formats for recording data onto a DVD disc, including DVD-Video and DVD-Audio, amongst others. Of these, DVD-Video is particularly intended for use with pre-recorded video content, such as a motion picture. As a result of the large storage capacity and ease of use, DVD discs are popular and commercially important.

Conveniently, an optical disc, such as a DVD-Video format disc, is played using a dedicated playback device with relatively simple user controls. DVD players for playing DVD-Video discs are relatively widespread. More detailed background information concerning the preferred example DVD-Video specification is available from DVD Forum at www.dvdforum.org and elsewhere.

A fundamental constraint arises in that the optical disc format specifications, such as DVD-Video, are designed for playback only. There is no way to generate new graphics and audio at the time that the audiovisual product is played. DVD-Video is an “archive” format. Consequently, all video and audio assets must be prepared in advance and recorded as part of the audiovisual product. Unfortunately, this leads to a relatively lengthy and complex authoring process.

A navigation structure is defined, in order to determine the order in which the audio and video assets should be played. For example, the DVD-Video specification defines cells as a basic unit to hold audio, video and sub-picture streams. The cells are grouped together within programs, and the programs linked to each other and hence known as Program Chains (PGCs). Program Chains are themselves grouped within video title sets (VTSs).

Typically, an optical disc format specification, such as the DVD-Video specification, provides a limited set of navigation commands. These commands are used to control navigation around the audiovisual product, such as by providing links from one cell to a next cell or previous cell, or links between Program Chains, amongst others. The navigation commands are defined by a command set, which is supported by all reproduction apparatus (e.g. DVD-Video players) which are compliant with the respective optical disc format specification. The reproduction apparatus thereby performs the recorded navigation commands during playback.

A problem arises in that creation of this navigation structure is labour-intensive, time-consuming and error-prone.

Currently available authoring tools for DVD-Video enable an author to add navigation commands by typing lines of text that incorporate symbolic references to the instructions that will ultimately be executed by the DVD-Video player. Manually typing each of these text commands is expensive and error prone. Also, including specific numerical references such as “Line 1” can mean that extensive renumbering is required should the author later decide to add an additional instruction. These text entries are then translated into binary sequences (bytecode) as part of the final audiovisual product. For example, a command “GoTo Line 1” is translated into bytecode as represented by the hexadecimal encoding “00 01 00 00 00 00 00 01”.

An example DVD authoring tool is disclosed in WO 99/38098 (Spruce Technologies) which provides an interactive graphical authoring interface and data management engine. This known authoring tool requires a relatively knowledgeable and experienced operator and encounters difficulties when attempting to develop an audiovisual product having a complex navigational structure. In particular, despite providing a graphical user interface, the navigational structure of the desired DVD-Video product must be explicitly defined by the author. Hence, creating a DVD-Video product with a complex navigational structure is still expensive, time-consuming and error-prone.

Another approach to authoring has been proposed by the present inventor in co-pending application WO03/094519, which outlines an improved method of authoring content for use in a DVD-Video audiovisual product. However, it is still desired to make further improvements and efficiencies in the creation of an audiovisual product.

An aim of the present invention is to provide a method and apparatus for preparing a navigation structure for use in an audiovisual product playable according to an optical disc format specification, such a DVD-Video specification. Ideally it is desired to reduce labour intensity, improve speed and/or reduce errors.

A preferred aim is to provide an authoring tool which is intuitive to use. Also, it is preferred to provide an authoring tool which is highly flexible and/or adaptable to many different authoring projects.

An aim of particularly preferred embodiments of the present invention is to allow efficient creation of audiovisual products playable according to an optical disc format specification such as a DVD-Video specification for compliant DVD-Video players.

According to the present invention there is provided an apparatus and method as set forth in the appended claims. Preferred features of the invention will be apparent from the dependent claims, and the description which follows.

In one aspect of the present invention there is provided a method of preparing a navigation structure for use in an audiovisual product playable according to an optical disc format specification. The method includes writing a scripting program in a human-oriented scripting program language. The scripting program includes an iterative loop with a variable adjusted according to iterations of the loop. When the scripting program is executed, the iterative loop creates, for each iteration of the loop, a navigation command for performing navigation operations during playback of the audiovisual product, such as from a command set for the optical disc format specification. The navigation command is defined according to the variable as adjusted for each iteration of the iterative loop. The one or more created navigation commands are added to an intermediate representation of the navigation structure.

In another aspect of the present invention there is provided a method of preparing a navigation structure for use in an audiovisual product playable according to an optical disc format specification such as DVD-Video, comprising the steps of: creating a program in a high-level human-oriented programming language, including an iterative loop with a variable adjusted according to iterations of the loop; initiating a navigation structure for the audiovisual product including at least one Video Title Set (VTS) structure and at least one Program Chain (PGC) structure; executing the program on a general-purpose computing platform, including the steps of running the iterative loop to create, for each iteration of the iterative loop, a navigation command from a virtual machine command set for DVD-Video, where the navigation command is defined according to the variable as adjusted for each iteration of the iterative loop, and adding the navigation command to the navigation structure; and translating the navigation structure into bytecode for use in an audiovisual product playable according to a DVD-Video specification.

The method may be implemented, wholly or at least in part, by dedicated hardware. As one example, the method is performed in a dedicated authoring apparatus for creating navigation structure for an audiovisual product playable according to an optical disc format specification such as DVD-Video. Particularly, a data file is produced as an intermediate step in the process of recording executable (playable) data onto a recording medium such as an optical disc. The present invention also extends to an authoring apparatus arranged to perform the method defined herein.

Optionally, the method of the present invention is implemented as a computer program, or a suite of computer programs. The program or programs are recorded on any suitable recording medium, including a removable storage such as a magnetic disc, hard disc or solid state memory card, or as a signal modulated onto a carrier for transmission on any suitable data network, such as the internet. In use, the method is suitably performed on a computing platform, ideally a general purpose computing platform such as a personal computer, or a client-server computing network.

For a better understanding of the invention, and to show how embodiments of the same may be carried into is effect, reference will now be made, by way of example, to the accompanying diagrammatic drawings in which:

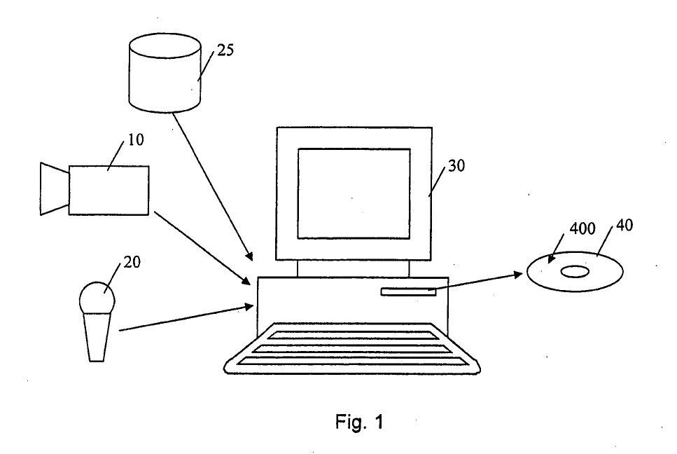

FIG. 1 is a schematic view of an apparatus for creating an audiovisual product, as used in preferred embodiments of the present invention;

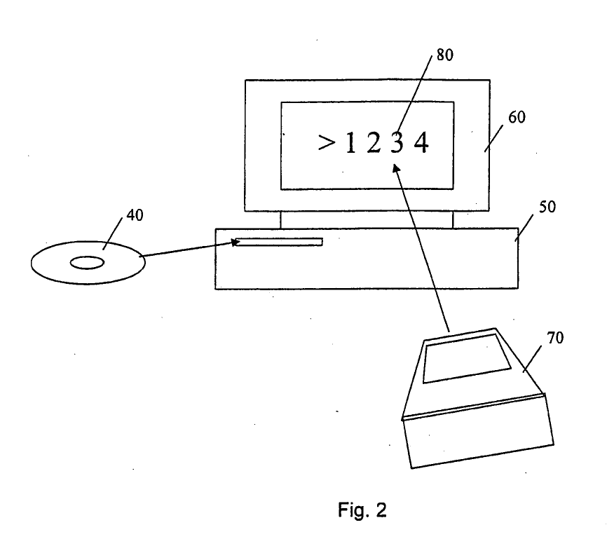

FIG. 2 is a schematic view of an example playback apparatus for reproducing an audiovisual product;

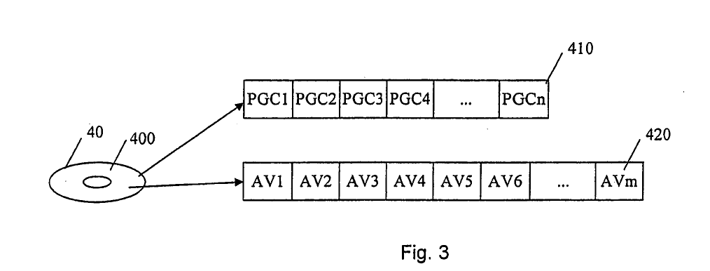

FIG. 3 is a schematic representation of an optical disc recording medium and data recorded thereon, as produced by preferred embodiments of the present invention;

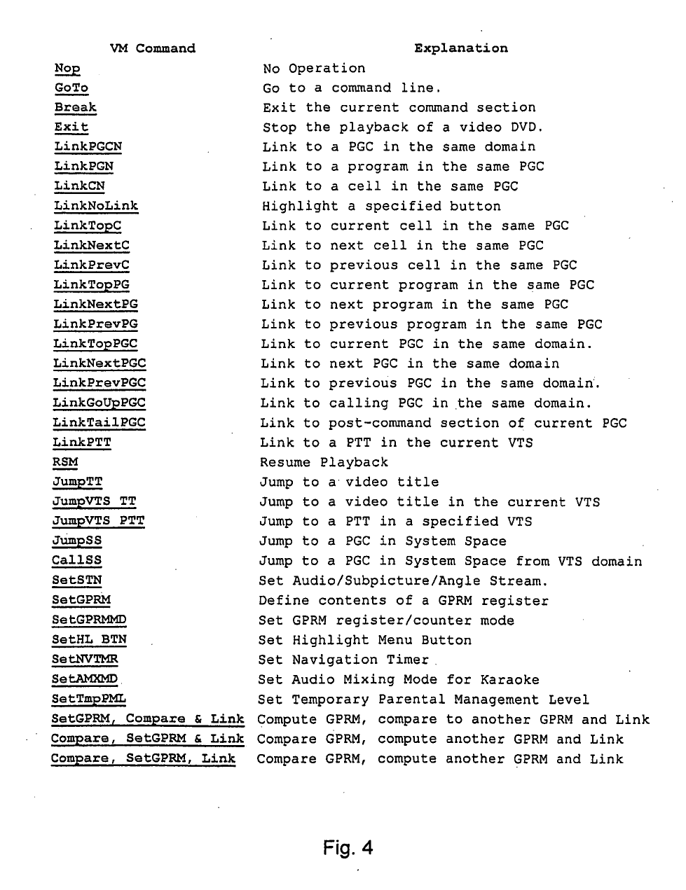

FIG. 4 is a table showing a textual representation of a virtual machine command set for DVD-Video;

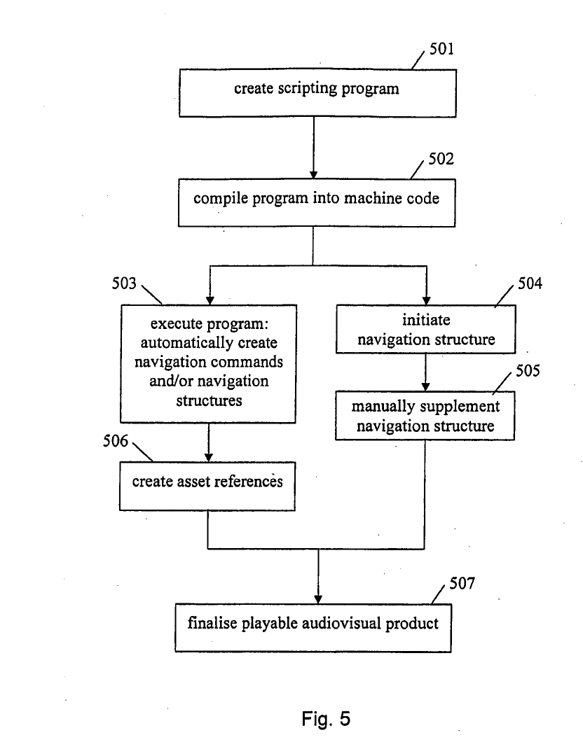

FIG. 5 is a schematic representation of a method according to a preferred embodiment of the present invention;

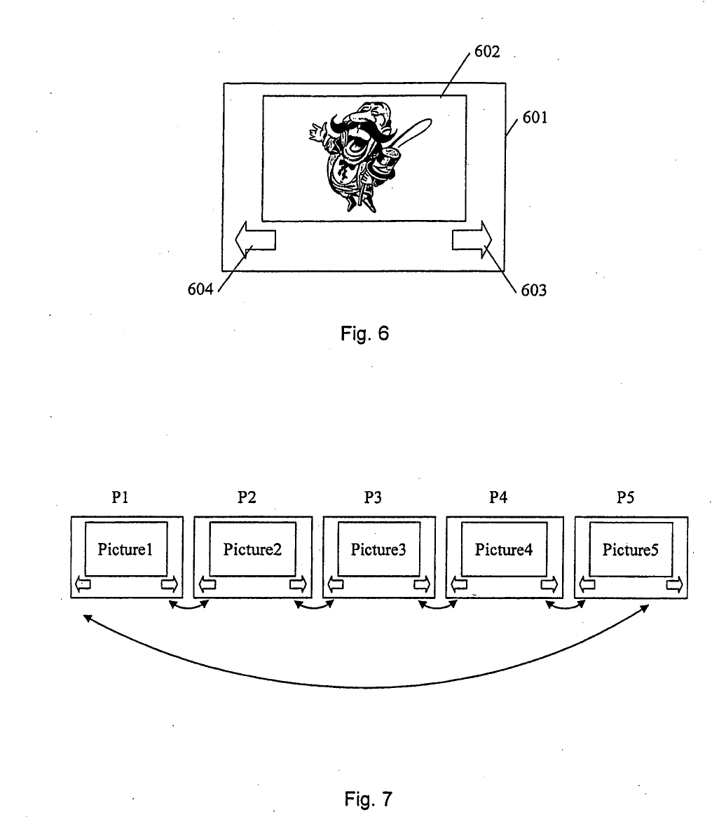

FIG. 6 is a screen representation of a photo gallery project;

FIG. 7 is a schematic representation to show navigational requirements of the photo gallery project of FIG. 6;

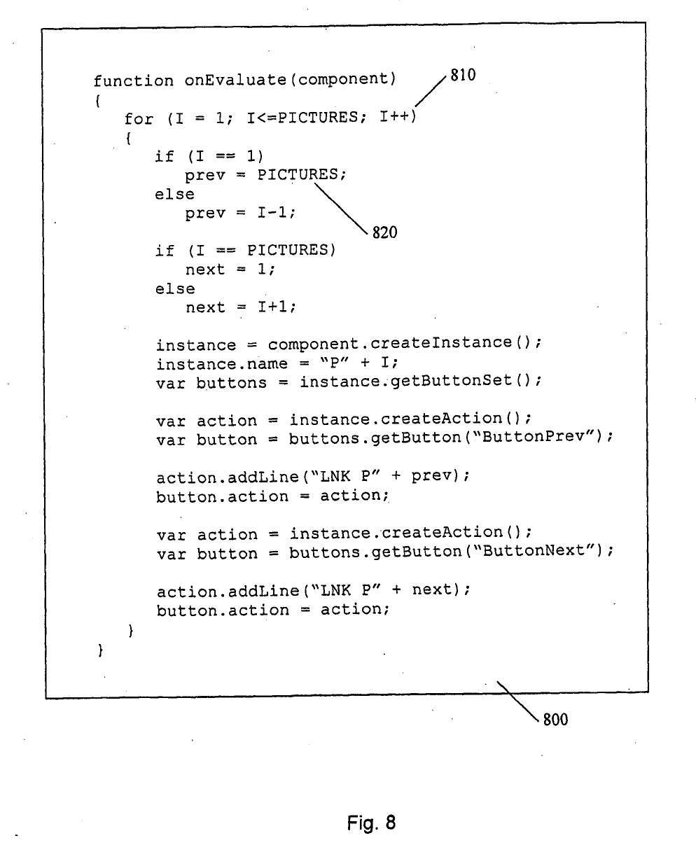

FIG. 8 is an example scripting program for use in the project of FIGS. 6 and 7;

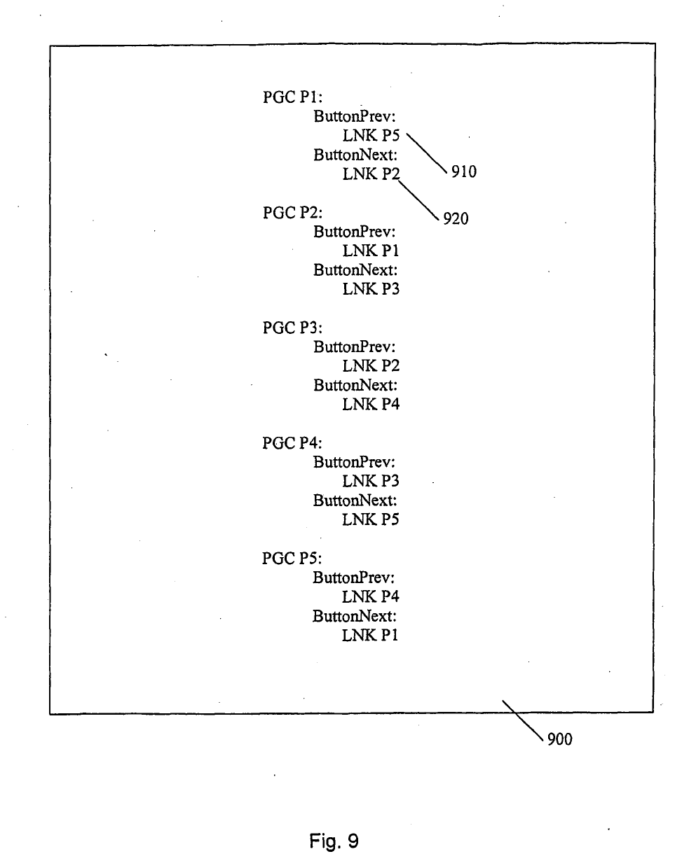

FIG. 9 is a textual intermediate representation of example navigation commands;

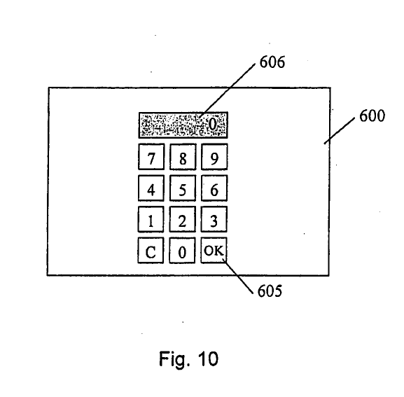

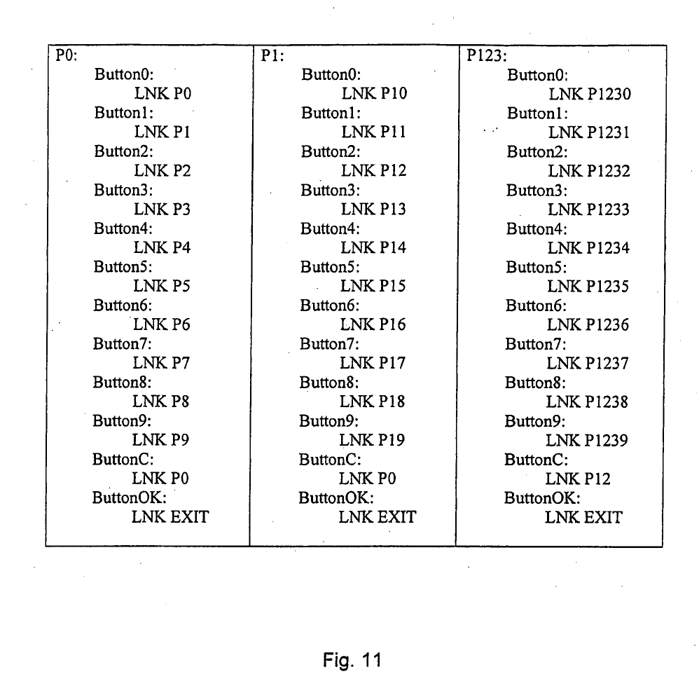

FIG. 10 is a screen representation of a PIN-code project;

FIG. 11 is a textual intermediate representation of example navigation commands; and

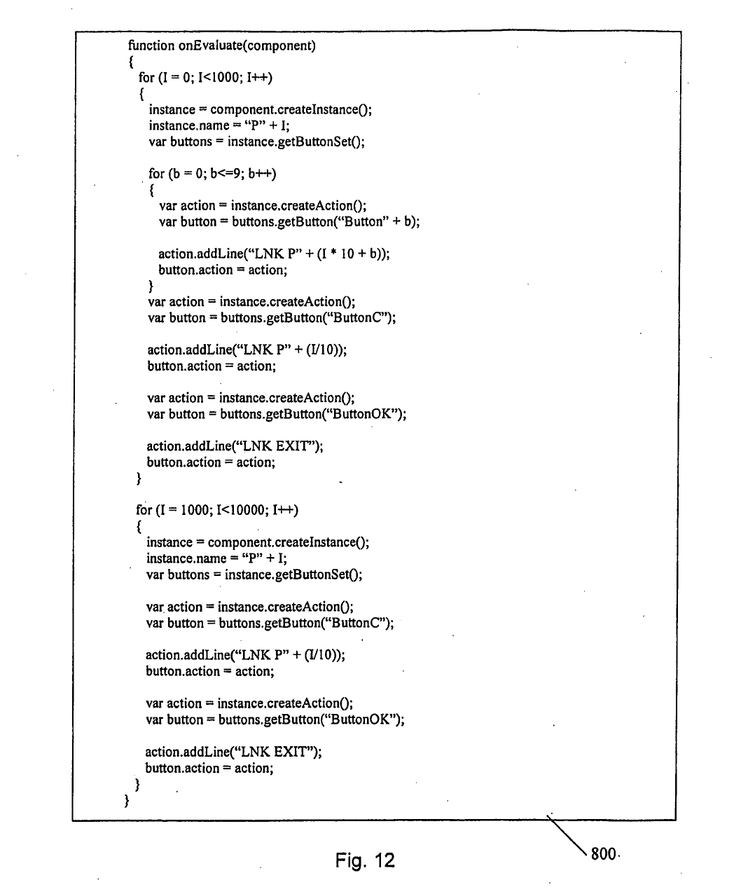

FIG. 12 is an example scripting program for use in the project of FIGS. 10 and 11.

The preferred embodiment of the present invention will be described with reference to the particular example of an audiovisual product recordable on an optical disc and playable on a DVD-Video player. However, it will be appreciated that the invention is applicable to a wide variety of other environments, particularly where audiovisual content is stored in some form of random access storage media. Also, it is envisaged that the DVD-Video format will itself be superseded over time and replaced with new format definitions. Hence, the present invention is seen to be applicable in other present and future environments.

FIG. 1 shows an example authoring apparatus as employed in preferred embodiments of the present invention. In this embodiment, the authoring apparatus includes a computing platform such as a client-server computer system, or a stand-alone personal computer 30. Optionally, raw audio and video data are received, such as through a camera 10 and a microphone 20, or are provided from other sources such as a file storage device 25, or are created within the authoring apparatus such as by image and sound creation software. The raw content data may include video clips, audio clips, still picture images, icons, button images and other visual content to be presented onscreen. The content is suitably in the form of MPEG or JPEG encoded files, but may take any suitable format.

The authoring apparatus 30 creates a navigation structure for the desired audiovisual product, as will be discussed in more detail below. The apparatus stores or outputs the navigation structure.

The navigation structure is stored or output firstly as an intermediate representation. Later, the intermediate representation is formatted and output in executable (playable) form. When the audiovisual assets are incorporated with the navigational structure, the finished audiovisual product 400 is written onto a storage medium such as a hard disc drive within the personal computer 30 or, preferably, onto an optical disc 40. The final audiovisual product is playable according to an optical disc format specification, such as DVD-Video.

The navigation structure is ideally created as an intermediate representation in a non-executable form. That is, the intermediate representation is not itself playable according to the optical disc format specification. In the preferred embodiment, the intermediate representation is a textual representation. The textual representation uses letters or symbols which are readily readable by a human. Most preferably, the textual representation is readily reviewed and edited by a human author, before finally committing the project to executable form. In another embodiment, the intermediate representation is in a binary form or a bytestream form, but is not yet playable according to the optical disc format specification. Optionally, a viewer or interpreter is used to review or edit the intermediate representation.

The navigation structure is itself a useful product. The navigation structure is optionally created, refined, evaluated and/or tested, separately from the audiovisual assets. This is especially useful in a commercial authoring environment. In particular, the intermediate representation of the navigation structure is stored, in order to be imported into other authoring systems for further treatment or analysis. Also, several parties may cooperate in creating, replicating and/or distributing commercial quantities of an audiovisual product such as a DVD-Video format optical disc. Such cooperation may include transmitting the navigation structure as an intermediate representation. Conveniently, during the authoring process, the navigation structure is held separately from a file or files holding the audiovisual assets.

FIG. 2 is a general overview of an apparatus for reproducing the audiovisual product 400, as may be employed in preferred embodiments of the present invention. The audiovisual product 400 on the optical disc 40 is received into a playback apparatus, in this case including a DVD player 50 and television screen 60. User controls are provided such as through a remote control handset 70. In one example embodiment, the audiovisual product 400 is controlled according to user input of an access code or PIN-code 80. As shown in FIG. 2, the access code 80 is presented on the television screen 60 in response to user inputs through the remote control apparatus 70.

FIG. 3 shows a structure of the audiovisual product 400 in more detail. The audiovisual product 400 includes a plurality of cells 420, in this case represented by cells AV1, AV2 . . . AVm. Each cell 420 contains a short section of audiovisual data. The cells are played in sequence, typically one after the other, in order to deliver the intended audiovisual presentation, under control of a playback sequence instruction 410. The sequence instructions 410 as shown in FIG. 3 are separate from the cells 420. Suitably, the cells 420 and the sequence instructions 410 are each allocated to structure locations within the audiovisual product, so as to enable navigation between instructions 410 and from instructions 410 to cells 420.

In the preferred example of DVD-Video format data, the cells 420 are played in sequence through their inclusion by reference in programs (PGs), which are in turn organised into Program Chains (PGCs). In FIG. 3, the sequence instructions 410 are represented by Program Chains PGC1, PGC2 . . . PGCn. Preferably, each cell 420 contains at least one video stream, at least one audio stream, and/or at least one sub-picture stream.

FIG. 4 is a table showing an example set of navigation commands as supported by current implementations of the DVD-Video specification, as a preferred example of an optical disc format specification. At machine level, the playable audiovisual product includes a binary coding of each command. The binary values are often expressed as hexadecimal bytecodes.

However, even this hexadecimal encoding is exceptionally unwieldy for all but the most skilled of authors. Hence, during authoring, the navigation commands in FIG. 4 are ideally represented in a textual form, such as by using mnemonics. In this example, the mnemonics are those commonly used by current DVD-Video authoring tools such as Scenarist (™) available from Sonic Solutions of Novato, Calif. (www.sonic.com). However, other forms of textual or symbolic representations (e.g. other systems of mnemonics) can be employed in other specific implementations.

Each command may include specific operands in addition to the basic instruction, according to predetermined semantics of the command set. Some examples are set out below:

| Example | Description |
|---|---|
| MOV GPRM1 10 | Set the value of General Parameter |
| | (GPRM) 1 to the value 10. |
| ADD GPRM2 10 | Add 10 to the value of General |
| | Parameter 2 |
| LNK label GPRM3 EQ 10 | Link (ie jump) to the code position |
| | marked by ‘label’ if the value of |
| | General Parameter 3 is 10. |
| RND GPRM4 10 | Set the value of General Parameter |
| | 4 to a value chosen randomly in the |
| | range 1 to 10. |

In some known authoring tools, the operands may be replaced by symbolic labels during an initial authoring stage. For example, an abstract label such as “SCORE” can be used initially in place of the specific parameter label GPRM1.

The navigation commands are placed into the DVD-Video navigation structure in four areas, namely:
1. In a “pre-command” section of a Program Chain (PGC), which is executed before the PGC is processed;
2. In a “post-command” section of a PGC, which is executed after the PGC has been processed;
3. In a “cell command” section, which is executed before a cell has been played; or
4. In a “button command” section, which is executed when the viewer activates a button.

The preferred embodiment of the present invention relates to a method and apparatus which is used to generate these navigation commands, and the related navigation structures such as Program Chains (PGCs), as will now be described in more detail below.

FIG. 5 is an overview of a preferred method for creating navigation structure, according to an embodiment of the present invention.

Step 501 comprises creating a program in a human-oriented programming language. In the preferred embodiment, this high-level program is a scripting program, such as JavaScript (JavaScript is a trade mark of Sun Microsystems Inc). JavaScript is a simple and user-friendly scripting language, which has been developed primarily for use in creating HTML-based web pages. However, the inventor has found that JavaScript (™) can also be used in other applications, and has benefits in environments other than HTML documents.

One advantage of JavaScript is that it is relatively simple to learn, and has become relatively widespread.

Also, by contrast with languages such as Java, C, C++ and others, JavaScript is a text-based scripting language that produces a textual output. However, other languages are suitable for use in the present invention. Examples include VBScript or JScript, amongst others.

The high-level scripting program includes at least one iterative loop, or similar functional looping structure. That is, the program will repeat one or more times any instructions contained within the loop, as appropriate. As a simple example, the loop is controlled by a variable such as the value “n”, with the variable increasing at each iteration of the loop, such as for n equals from 1 to 10.

Step 502 comprises preparing the high-level scripting program for execution (i.e. as binary machine code) on appropriate hardware such as an execution unit of the general purpose computing platform 30 of FIG. 1. That is, depending on the implementation of the high-level scripting program and the execution environment employed, it is first necessary to compile or interpret the prepared scripting program in order that the program can be executed on the hardware. Preferably, the scripting program is executed on a browser that supports the scripting programming language.

Step 503 comprises executing the high-level program. Executing the programming includes running the iterative loop, i.e. executing the loop for values of n from 1 to 10. For each iteration of the loop, a textual representation of a navigation command is automatically created. That is, each created navigation command is a program instruction which corresponds to one or more navigation operations to be performed during playback of the audiovisual product. Suitably, the navigation command is a command taken from the command set appropriate to the optical disc format specification, such as the DVD-Video Virtual Machine command set shown in FIG. 4. Here, there is a direct one-to-one correlation between the created navigation commands and the instructions recorded in the navigation structure of the audiovisual product.

The navigation command is defined according to the variable (in this case “n”) as adjusted for each iteration of the iterative loop. That is, in the first iteration, say n=1, the navigation command is defined appropriate to a value of n=1. In the second iteration then the navigation command is defined appropriate to n=2, and so on up to n=10. In this simple example, the loop control variable “n” is used to define a command operand. However, in most practical cases, a plurality of variables are defined and iteratively adjusted to control either the command (instruction) or one or more operands.

The navigation commands are provided in textual form to be incorporated within a textual intermediate representation of the navigation structure. Suitably, the navigation commands are added to a cell within a Program Chain (cell commands), or to an appropriate position within a Program Chain (pre- and post-commands), or in the navigation pack of a menu pack (button commands).

The step 503 may also include automatically creating new navigation structure elements within the navigation structure. For example, the step 503 may include automatically generating new cells, PGCs or VTS structural elements using the scripting program.

In the preferred embodiment, the navigation structure is suitably defined as a textual document, or a text-based database, and held within a memory or disc storage of the personal computer 30. This textual representation is a repository of (at least part of) the navigation structure of the audiovisual product, according to the optical disc format specification (e.g. DVD-Video). The prepared textual navigation structure includes representations of the navigation locations (e.g. PGCs) in the product, and the navigation commands (e.g. links). The textual representation of the navigation structure is suitably stored for later use, or transmitted to another party for further work.

Step 504 comprises providing an initial navigation structure for the audiovisual product. The navigation structure is suitably initiated by defining at least one navigation structure element such as at least one video title set (VTS) structure, which holds at least one Program Chain (PGC) structure. That is, the navigation structure is provided with a set of initial locational and/or navigational elements as appropriate to the project under consideration. In one embodiment, this initiation step is performed manually, such as by an author typing initiation text into a text document, or by defining a textual database to hold the project under consideration. Alternatively, the navigation structure is initiated automatically as part of executing the program in step 503. In some embodiments, executing the scripting program provides a textual representation of part of a navigation structure, which is conveniently later incorporated into another navigation structure such as by a text-based cut and paste operation.

In step 505, the method optionally includes manually adding further navigation structure to the textual representation, such as adding further structural elements (PGC) and/or adding further navigation commands. These additional structural elements and commands supplement the navigation structure and navigation commands produced automatically by the scripting program. Suitably, the structures and/or commands are added manually by the author either by direct textual inputs, or through a graphical user interface as in prior authoring tools such as described by Spruce Technologies or Sonic Solutions (see above).

As shown schematically at step 506 of FIG. 5, executing the scripting program may further automatically generate references to audio and video assets. Suitably, the audio and video assets are stored in a storage system, such as the file storage 25 of FIG. 1. The scripting program automatically generates appropriate path references for each video or audio asset. Ideally, the asset references are derived from a variable of the iterative loop, in a similar manner to the generation of navigation commands and navigation structures as discussed herein. That is, a set of asset references are automatically created by executing the scripting program.

In step 507, the navigation structure, including the structural elements and navigation commands, is translated into corresponding numerical structural locations and operational bytecodes (representing binary values), in order to produce a product which is playable according to an optical disc format specification, i.e. by a DVD-Video player. Ideally, the video, audio and sub-picture assets are imported at this stage and placed as appropriate within the navigation structure, i.e. within appropriate cells. Conveniently, the assets are imported by calling files from the file storage 25 according to asset path references-provided within the navigation structure.

In commercial-scale operations, step 507 suitably includes preparing a disc image recorded onto an appropriate storage medium, such as a digital magnetic tape. The disc image is used to create a physical master disc (cutting master). The master disc is used in a replication process to create playable discs for distribution such as through retail outlets. Alternatively, in smaller-scale operations, the binary disc image is burnt directly onto an optical disc. The optical discs are then ready for playback in a standard reproduction apparatus, such as a dedicated set-top DVD-Video player, portable DVD player or in-car DVD player.

Two specific examples are provided below, in order to explain the principles and operations of the preferred embodiments of the present invention in more detail.

### EXAMPLE 1

FIG. 6 shows how an audiovisual product is provided to implement a photo gallery application. It is desired to display a series of separate still images (or even movie clips) in a picture area 602 of a screen 601. Movement between the images is to be controlled by the viewer using “next” and “previous” buttons 603, 604. In the DVD-Video specification, it is relatively difficult and complex to implement a navigation structure to perform the necessary navigational movements between the images.

FIG. 7 is a schematic representation of navigational movements between five pictures (P1-P5) in the photo gallery. Each picture corresponds to one menu PGC that contains two buttons. In a conventional DVD authoring tool, this project would be realised by manually creating five separate menu PGCs P1-P5, and then manually associating buttons and links with each menu PGC. This process is inherently labour-intensive and time consuming. Since these are created manually, it would be very easy for an author to make a mistake. It is costly and time-intensive to test that the resultant product has been authored correctly. This simple example employs just two buttons across five menus. In practical examples, there may be many more buttons applied across potentially thousands of PGCs. Although, in theory, the DVD-Video specification is able to support such a project, in practice the project is not feasible because labour costs are prohibitive.

In the preferred embodiment of the present invention, the author creates a program in a high-level language, ideally JavaScript (™) as explained above.

FIG. 8 is a program code listing showing an example scripting program 800 used to implement the project shown in FIGS. 6 and 7. As shown in FIG. 8, the scripting program defines an iterative loop 810 with a number of steps given by the value of a loop control variable “PICTURES”, which is five in this example, i.e. I=1 to 5. For each step of the loop, two variables 820 are defined, namely “PREV” and “NEXT”, which are adjusted as appropriate for each iteration of the loop. Then, for each step of the loop 810, a new element of the navigation structure is created, in this case a new menu Program Chain, PGC P1, PGC P2 etc. Each new instance incorporates two buttons (button PREV and button NEXT) which are linked to appropriate other structures. The line:
action.addline(“LNK P”+prev)
   adds a command which, in this case, corresponds to the LNK instruction to link a button to a PGC.

When the author has written the program, execution of the program yields a textual representation of the desired navigation structural elements (menu PGCs) and appropriate navigation commands (LNK P5, etc).

FIG. 9 is a textual representation 900 of the navigation structure and navigation commands 910 automatically created by execution of the program 800 shown in FIG. 8. Here, each command 910 has an operand 920 derived from the loop variable 820. In this simple example, the textual representation is relatively short. However, if it is desired to produce a picture gallery having 100 or even 1000 pictures, then it is now easy to change the loop control variable “PICTURES” to be 100 or 1000 and produce the structure and commands of FIG. 9 but increased by twenty-fold or even two-hundred-fold.

Optionally, the navigation structure elements and navigation commands produced automatically by the program are supplemented by additional structural elements and commands entered manually.

The scripting program may further include automatic generation of references to appropriate audio and video assets. Suitably, these audio and video assets are stored in a storage system such as the remote file storage 25 of FIG. 1. The scripting program automatically generates appropriate path references for each video or audio asset. In this example, such assets represent each of the pictures (picture 1-picture 5), a background screen image, button sub-picture images, button audio, or audio commentary associated with each picture.

This example illustrates the power and convenience applied by preferred embodiments of the present invention. Many new or previously cost-prohibitive projects can now be authored for playback using a DVD-Video player.

### EXAMPLE 2

A second example DVD project performs the functionality equivalent to a numeric display with which a viewer is able to enter a four-digit PIN code. It is desired to display a number as each digit is entered by the user. The overall presentation remains constant, but the specific numerical value is dependent upon a sequence of user inputs. Even for this simple four-digit PIN code project, a total of 10,000 separate menu PGCs are required, representing the values 0 to 9999.

FIG. 10 is an example screen representation 600 showing menu buttons 605 representing the digits 0-9, along with “cancel” and “OK” buttons. The “cancel” button deletes the previously entered digit. The “OK” button exits the project. A sub picture area 606 is used to display the numerical value entered by the viewer during playback.

FIG. 11 is a textual representation of a first menu PGC (here called “P0”) for displaying the value “0” in the sub picture area 606. Each of the buttons 605 is associated with a navigation command that jumps to the next appropriate menu PGC (using the LNK command or equivalent). For example, pressing button 1 jumps to menu “P1” to show the value “1”. Pressing button 5 jumps to PGC 5 to show the value “5” and so on. Hence, this P0 menu links to twelve other locations (P0-P9, cancel and OK) as listed in FIG. 11.

Secondly, FIG. 11 shows the set of links associated with the PGC “P1” which displays the value “1”. Thirdly, FIG. 11 shows the navigation commands associated with the buttons for menu “P123” which displays the value “123”. Here, it can be seen that pressing the “cancel” button links back to the previous menu “P12” (i.e. deleting “3” and reverting to “12”).

FIG. 12 is an example of program code which will automatically create the necessary navigation structures and navigation commands to implement the PIN code project of FIGS. 10 and 11. The script is arranged in two sections. The first will cause 1000 structures to be created; one for each menu for the value “0” to “999”, and each with navigation commands for twelve buttons. The second section of the script defines the structures for the values 1000 to 9999. For these, the numeric keys are disabled (four digits have already been entered), and the only active keys are the cancel and OK buttons.

The authoring method and apparatus described above has many advantages. Creating a program script allows an author to produce audiovisual products which are more complex and more entertaining than has been possible previously in practice. Repetitive manual tasks are avoided, which were previously time consuming, expensive and error prone.

The preferred embodiments of the present invention provide considerable efficiencies and savings when performing functions such as creating localised variants of a movie or other product (e.g. 4:3 or 16:9 format; NTSC or PAL format) and language variations (e.g. text labels for menus and buttons).

Further, the navigational structure of a DVD-Video product can be defined and prototyped without the need to create or link to any video or audio assets. The navigation structure can be created in isolation, allowing rapid development and creative experimentation.

Further still, automatic creation of navigation commands and navigation structures leads to a high level of confidence and significantly reduces requirements for testing and quality control. For example, a select few commands and routines are checked, and the remainder can then be assumed to be in order.

The authoring method and apparatus significantly enhance the range of features available in existing categories of audiovisual products, such as movie presentations, and allow completely new categories of audiovisual products to be produced simply and easily, such as quiz-based games and puzzle-based games, amongst others. The authoring method and apparatus allow the production of many different types of information products, such as picture galleries, catalogues, directories, reference guides, dictionaries and encyclopaedias.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of authoring a navigation structure for use in a self-contained audiovisual product playable according to an optical disc format specification, comprising the steps of:
creating a scripting program in a human-oriented scripting program language for authoring a navigation structure for a self-contained audiovisual product, the scripting program including an iterative looping structure with a variable adjusted according to iterations of the loop; and
executing the scripting program, including running the looping structure to create, for each iteration of the looping structure, a navigation command from a command set for the optical disc format specification, where the navigation command is defined according to the variable as adjusted for each iteration of the looping structure, and adding the navigation command to an intermediate representation of the navigation
structure, the intermediate representation suitable for storage upon a non-transitory storage medium; and
authoring a self-contained audiovisual product with a navigation structure resulting from the intermediate representation.

2. The method of claim 1, wherein the executing step comprises compiling or interpreting the scripting program into a second program in a machine-oriented programming language, and then executing the second program.

3. The method of claim 1, wherein the executing step comprises executing the scripting program on a browser that supports the scripting programming language, and creating the navigation commands in a textual repository.

4. The method claim 1, comprising storing the intermediate representation of the navigation structure as a text file or in a text-based database.

5. The method of claim 4, wherein the text file is an ASCII-readable text file.

6. The method of claim 1, wherein the running step comprises creating a set of related navigation commands, where each navigation command has an operand which is defined according to the variable of the looping structure.

7. The method of claim 1, wherein an operand of the navigation command is modified in each iteration of the looping structure according to the variable.

8. The method of claim 1, wherein the running step comprises creating a sequence of navigation commands within each iteration of the looping structure.

9. The method of claim 1, wherein the iterative looping structure defines at least a first variable and a second variable, which are each adjusted according to iterations of the looping structure; and
the running step comprises creating navigation commands having operands defined according to the first variable and/or the second variable.

10. The method of claim 1, wherein the looping structure has a predetermined number of iterations according to the loop control variable.

11. The method of claim 1, wherein the looping structure is a recursive loop or a recursive function which repeats until a predetermined exit condition is satisfied.

12. The method of any preceding claim 1, wherein the executing step further comprises automatically creating a new program chain structure and adding the new program chain structure to the intermediate representation of the navigation structure.

13. The method of claim 1, wherein the running step comprises, for each iteration of the looping structure:
creating a program chain structure, and
creating a navigation command with respect to the program chain structure, wherein the program chain structure and/or the navigation command is defined according to a value of the variable for a current iteration of the looping structure.

14. The method of claim 1, wherein the navigation command is selected from the group consisting of a pre-command to be executed before a program chain is processed, a post-command to be executed after a program chain is processed, a cell command to be executed before a cell within a program chain is played, and a button command to be executed in response to activation of a button.

15. The method of claim 1, wherein the executing step comprises automatically creating a path reference to an audio or video asset, and adding the path reference to the intermediate representation of the navigation structure.

16. The method of claim 1, wherein the running step comprises automatically creating links from a program chain structure and/or a navigation command to a video, audio or sub-picture asset.

17. The method of claim 1, wherein the running step comprises automatically generating a video, audio or sub-picture asset, and linking the asset to a created program chain structure and/or a navigation command.

18. The method of claim 1, further comprising combining an automatically created program chain structure and/or an automatically created navigation command created by the executing step with one of a group consisting of a video title set structure, a program chain structure and a navigation command created manually.

19. The method of claim 1, further comprising translating the intermediate representation of the navigation structure into bytecodes for use in an audiovisual product playable according to an optical disc format specification.

20. The method of claim 19, wherein the translating step includes allocating numerical structural locations to portions of the navigation structure, and defining numerical structural locations for jumps within each navigation command.

21. The method of claim 20, wherein the translating step comprises translating into bytecode the intermediate representation of the navigation commands and the numerical structural locations of the navigation structure.

22. The method of claim 19, 20 or 21, further comprising recording the audiovisual product as a binary disc image.

23. The method of claim 22, further comprising producing an optical disc according to the binary disc image, where the optical disc is playable according to an optical disc format specification.

24. A computer program stored in a non-transitory computer readable medium operable by a computer to perform the steps of the method as set forth in any of claims 1 to 23.

25. An authoring apparatus including a central processing unit (CPU) adapted to perform the method of any of claims 1 to 23.

26. An authoring apparatus including a central processing unit (CPU), the authoring apparatus adapted to prepare a navigation structure for use in a self-contained audiovisual product playable according to an optical disc format specification, comprising:
a browser interface to create a scripting program in a human-oriented scripting program language for authoring a navigation structure for a self-contained audiovisual product, the scripting program including an iterative loop with a variable adjusted according to iterations of the loop; and
an execution unit to execute the scripting program, including creating, for each iteration of the loop, a navigation command from a command set for the optical disc format specification, where the navigation command is defined according to the variable as adjusted for each iteration of the iterative loop, and adding the navigation command to an intermediate representation of the navigation structure; and
a storage unit to store the intermediate representation of the navigation structure for use in authoring a self-contained audiovisual product with a navigation structure resulting from the intermediate representation.

27. The method of claim 1, further comprising combining an automatically created navigation command created by the executing step with one of a group consisting of a video title set structure, a program chain structure and a navigation command created manually.

28. A system including a central processing unit (CPU) adapted for automatically authoring a navigation structure for use in a self-contained audiovisual product playable according to an optical disc format specification, comprising the steps of:
a command set defining a plurality of navigation commands for an audiovisual reproduction apparatus;
a human-oriented scripting program for automatically authoring a navigation structure for use in a self-contained audiovisual product playable in the audiovisual reproduction apparatus, the scripting program including an iterative loop with a variable adjusted according to the iterations of the loop, the scripting program operable to automatically, for each iteration of the loop;
select from the plurality of navigation commands a navigation command defined according to the variable as adjusted for each iteration of the loop; and
add the navigation command to an intermediate representation of the navigation structure, the intermediate representation suitable for storage upon a non- transitory storage medium; and
authoring a self-contained audiovisual product with a navigation structure resulting from the intermediate representation.

29. The system of claim 28, wherein the intermediate representation of the navigation structure is in a non-executable form for the audiovisual reproduction apparatus.

30. The system of claim 28, wherein the intermediate representation of the navigation structure is formatted in executable form for the audiovisual reproduction apparatus.

31. The system of claim 30, wherein the navigation structure in executable form is incorporated with at least one audiovisual asset and disposed to a non-transitory medium as an audiovisual product for a playback device.
